(19) United States
(12) Patent Application Publication
(10) Pub. No.: US 2021/0281608 A1
(43) Pub. Date: Sep. 9, 2021

(54) SEPARATION OF HANDSHAKE AND RECORD PROTOCOL

(71) Applicant: International Business Machines Corporation, Armonk, NY (US)

(72) Inventors: Matthew Green, Ashmore (AU); Narayana Aditya Madineni, Southport (AU); Peter T. Waltenberg, Gold Coast (AU); Michael W. Gray, Guanaba (AU); Leigh S. McLean, Nerang (AU); Alexander John Hennekam, Broadbeach Waters (AU); Simon D. McMahon, Gold Coast (AU)

(21) Appl. No.: 16/810,364

(22) Filed: Mar. 5, 2020

(51) Int. Cl. H04L 29/06; H04L 9/32; H04L 9/08; G06F 9/455

(52) U.S. Cl. CPC H04L 63/166; H04L 63/0442; H04L 9/3263; H04L 9/0825; G06F 2009/45583; G06F 9/45558; G06F 2009/4557; G06F 2009/45595; H04L 9/0861

(57) ABSTRACT

A method, a computer program product, and a system for transport layer security protocol functions in separate instances. The method includes receiving, by a handshake processor instance, a TLS connection request from a client to a server. The method further includes establishing a TLS connection including connection secrets by the handshake processor instance. Once established, the method proceeds by transmitting the connection secrets to a connection processor instance. The method further includes deleting the connection secrets stored on the handshake processor instance and processing application data by the connection processor instance.

### BACKGROUND

The present disclosure relates to transport layer security, and more specifically, to separating the handshake protocol processing and the record protocol processing into independent components.

Transport layer security (TLS) protocol provides communications security over a computer network. Applications such as web browsing, email, instant messaging, and voice over IP (VoIP) can utilize the TLS protocol to secure the communication between a server and a client. The TLS protocol includes a record protocol and a handshake protocol. The record protocol provides data confidentiality using symmetric key cryptography and data integrity using a keyed message authentication checksum (MAC). The handshake protocol handles the authentication and key exchange necessary to establish or resume secure sessions.

### SUMMARY

Embodiments of the present disclosure include a computer-implemented method for performing TLS protocol functions in separate processing instances. The computer-implemented method includes a handshake processor instance receiving a TLS connection request from a client to a server. The handshake processor instance is configured to perform TLS handshake protocol functions. The computer-implemented method also includes establishing a TLS connection including connection secrets and performed by the handshake processor instance. The connection secrets include a master secret used during a TLS session for implementing symmetric encryption between the server and the client. The computer-implemented method further includes transmitting the connection secrets to a connection processor instance. The connection processor instance is configured to perform TLS record protocol functions. Once transmitted, the computer-implemented method includes deleting the connection secrets stored on the handshake processor instance. The computer-implemented method further includes processing application data by the connection processor instance. The application data includes communication between the server and the client.

Further embodiments of the present disclosure include a computer program product for performing TLS protocol functions in separate processing instances which can include a computer readable storage medium having program instruction embodied therewith, the program instruction executable by a processor to cause the processor to perform a method. The method includes a handshake processor instance receiving a TLS connection request from a client to a server. The handshake processor instance is configured to perform TLS handshake protocol functions. The method also includes establishing a TLS connection including connection secrets and performed by the handshake processor instance. The connection secrets include a master secret used during a TLS session for implementing symmetric encryption between the server and the client. The method further includes transmitting the master secret to a connection processor instance. The connection processor instance is configured to perform TLS record protocol functions. Once transmitted, the method includes deleting the connection secrets stored on the handshake processor instance. The method further includes processing application data by the connection processor instance. The application data includes communication between the server and the client.

Additional embodiments are directed to a TLS processing system for performing TLS protocol functions in separate processing instances configured to perform the method described above. The present summary is not intended to illustrate each aspect of, every implementation of, and/or every embodiment of the present disclosure

### BRIEF DESCRIPTION OF THE DRAWINGS

These and other features, aspects, and advantages of the embodiments of the disclosure will become better understood with regard to the following description, appended claims, and accompanying drawings where:

FIG. 1 is a block diagram illustrating a TLS process separation system, in accordance with embodiments of the present disclosure.

FIG. 2 is a flow chart of a TLS connection process, in accordance with embodiments of the present disclosure.

FIG. 3 is a high-level block diagram illustrating an example computer system that may be used in implementing one or more of the methods, tools, and modules, and any related functions, described herein, in accordance with embodiments of the present disclosure.

FIG. 4 depicts a cloud computing environment, in accordance with embodiments of the present disclosure.

FIG. 5 depicts abstraction model layers, in accordance with embodiments of the present disclosure.

While the present disclosure is amenable to various modifications and alternative forms, specifics thereof have been shown by way of example in the drawings and will be described in detail. It should be understood, however, that the intention is not to limit the particular embodiments described. On the contrary, the intention is to cover all modifications, equivalents, and alternatives falling within the scope of the present disclosure. Like reference numerals are used to designate like parts in the accompanying drawings.

### DETAILED DESCRIPTION

The present disclosure relates to transport layer security, and more specifically, to separating the handshake protocol processing and the record protocol processing into independent processing instances. While the present disclosure is not necessarily limited to such applications, various aspects of the disclosure may be appreciated through a discussion of various examples using this context.

Packets of communication transmitted over a network (e.g., the Internet) typically pass through a multitude of routers before arriving at a desired destination. The communication between a client and a server can include sensitive information such as passwords, credit card information, social security numbers, tax identification numbers, and the like. Malicious actors (e.g., individuals, organizations, governments), also referred to as attackers, can intercept the communication and attempt to obtain the sensitive information at any point along this communication pathway. To prevent this, the client and the server can implement the TLS protocol to encrypt the communication being exchanged.

To initially establish a communication link (i.e., a socket) between a client and a server, the client transmits a synchronize packet to the server. Once received, the server responds back to the client with a synchronize and acknowledge packet. The client can then acknowledge the acknowledgement and a connection is created. This three-packet communication is commonly referred to as the Transport Control Protocol (TCP) handshake. The connection is associated with a source port and a destination port, which are attached to each subsequent packet in the communication stream. Web clients, also known as web browsers, establish these sockets with web servers. After the socket has been established, the web browser begins following the rules set forth by the Hypertext Transport Protocol (HTTP) to request documents and other types of information.

Once a socket is established between a client and a server, the TLS protocol defines a second handshake, the TLS handshake, that can be performed to establish a secure channel of communication over the TCP layer. The TLS handshake protocol sets the requirements used during the negotiation between the client and the server. The TLS handshake determines what cipher suite will be used to encrypt the communication, verifies the server, and establishes the secure connection. Once the secure connection has been established, the TLS record protocol determines how communication is handled between the client and the server.

Limitations on security remain, however, in communication being transmitted via the TLS protocol. Currently, both the TLS handshake protocol and the TLS record protocol process data within the same application space. A successful cyber-attack, or exploitation, on the application space can reveal record layer connections keys and handshake layer secrets such as private keys. Once revealed, the attacker could use those secrets to gain unauthorized access. Any additional secret information being transmitted over the breached TLS connection would be exposed.

Embodiments of the present disclosure may overcome the above, and other problems, by using a TLS process separation system. The TLS process separation system includes a handshake processor instance and a connection processor instance. The handshake processor instance is configured to perform TLS handshake protocol functions and the connection processor instance is configured to perform TLS record protocol functions. Using the handshake processor instance, the TLS process separation system is configured to receive a TLS connection request from a client to a server and establish a TLS connection between the client and the server. Connection secrets, such as a master secret, are generated during this process. The TLS process separation system is further configured to transmit the connection secrets from the handshake processor instance to the connection processor instance, and then delete the connection secrets from the memory accessible to the handshake processor instance. Using the connection processor instance, the TLS process separation system is configured to process communication between the client and the server during the TLS session.

More specifically, the TLS process separation system described herein separates TLS handshake processing from connection processing. By doing so, access to handshake secrets, such as private keys, are restricted which diminishes the attack surface for a would-be attacker. An attack surface refers to the sum of different points, or attack vectors, where an unauthorized user can try to enter data, or extract data, from an environment. In other words, the TLS process separation system reduces the attack surface of a TLS connection and session by processing the handshake in a separate isolated instance. The isolated instance provides for a hard memory separation from the connection processor instance. Additionally, a secure transmission of connection secrets from the handshake processor instance to the connection processor instance provides additional security measures.

By way of example, a web client, via a web browser, sends a request to a server to establish a secure connection between the client and the server. On the server, the TLS process separation system responds to the request by having a handshake processor instance handle the TLS handshake protocol functions. The handshake processor instance completes the handshake requirements and transmits the required connection secrets to the connection processor instance. Both the handshake processor instance and the connection processor instance are distinct isolated instances that provide a hard memory separation between the two instances. Once the transmission of the connection secrets is complete, the handshake processor instance disconnects from the connection processor instance and deletes the connection secrets from its memory. By doing so, any access attempts to the handshake processor instance from the connection processor instance is prevented, and vice versa.

In some embodiments, the separation requirement between the handshake processor instance and the connection processor instance is enforced by additional security by applying physical security controls to the handshake processor instance. Physical security controls protect against unauthorized physical access to information assets. Typically, physical security controls come in the form of networked devices that are Internet Protocol (IP) enabled. These networked devices can provide an additional layer of defense to safeguard the information stored on the handshake processor instance.

Additionally, or alternatively, the handshake processor instance and the connection processor instance can be isolated in various ways. In some embodiments, the handshake processor instance and the connection processor instance operate within the same computer system. The system can have safeguards in place that prevent communication between the two instances and also have hard memory separation between the instances. For example, process isolation can be implemented between the two instances. Process isolation refers to a set of technologies designed to protect each process from other processes on a system. Process isolation can be implemented using virtual address space, where the handshake processor instance's address space is different from the connection processor instance's address space. This prevents either instance from accessing or writing to the other instance's memory.

In some embodiments, the handshake processor instance and the connection processor instance operate as isolated containers. A container is a standardized unit of software. The unit of software, or service/application running within a container, has full, private access to their own isolated view of operating system (OS) constructs. As such, containers can be viewed as encapsulated, individually deployable components running as isolated instances on the same kernel. The handshake processor instance and the connection processor instance can each operate on separate containers to provide isolation between the instances. In some embodiments, the handshake processor instance operates on premise of a secure server and the connection processor instance operates on the cloud. This can allow for the addition of physical security controls implemented on the handshake processor instance to provide for more security. In some embodiments, the connection processor instance operates on premise of a secure server and the handshake processor instance operates on the cloud.

In some embodiments, the handshake processor instance and the connection processor instance operate as separate virtual machine. Virtual machines are emulations of a computer system that provide the functionality of a physical computer. Typically, a virtual machine contains an entire operating system, which can then be used to run instances such as the handshake processor instance and the connection processor instance.

It is to be understood that the aforementioned advantages are example advantages and should not be construed as limiting. Embodiments of the present disclosure can contain all, some, or none of the aforementioned advantages while remaining within the spirit and scope of the present disclosure.

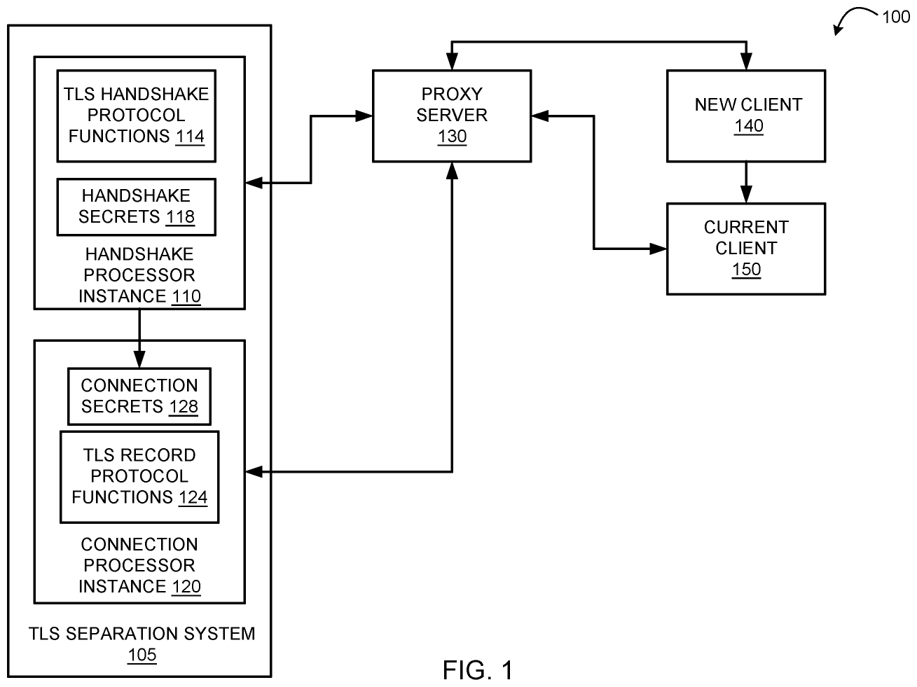

Referring now to FIG. 1, shown is a block diagram illustrating a TLS separation system 105 operating within a computing environment 100, in accordance with embodiments of the present disclosure. The computing environment 100 includes the TLS separation system 105, a proxy server 130, a new client 140, and a current client 150. The TLS separation system 105 includes a handshake processor instance 110 and a connection processor instance 120. The handshake processor instance includes TLS handshake protocol functions 114 and handshake secrets 118. The connection processor instance 120 includes TLS record protocol functions 124 and connection secrets 128. In some embodiments, the handshake processor instance 110 establishes a TLS connection with the new client 140 through the proxy server 130. In some embodiments, the connection processor instance 120 establishes a TLS session with the current client 150 through the proxy server 130.

The handshake processor instance 110 is a component of the TLS separation system 105 configured to perform a TLS handshake between a server and a new client 140 to create a secure connection, in accordance with embodiments of the present disclosure. A TLS handshake refers to the process of establishing a secure communication between the new client 140 and the server. The TLS handshake determines what cipher suite will be used to encrypt the communication, verifies the server, and establishes that a secure connection is in place before beginning actual transfer of data.

To perform the handshake, the TLS processor instance utilizes TLS handshake protocol functions 114. The TLS handshake protocol functions 114 are a component of the handshake processor instance that provide the framework and requirements necessary to complete the TLS handshake. The TLS handshake is performed using asymmetric encryption, where a public key and a private key are used. The public key and the private key are considered handshake secrets 118 and are stored by the handshake processor instance 110 to encrypt and decrypt the communication. The public key is used for encryption and the private key is used for decryption during the TLS handshake process. During the TLS handshake process, the server and the client utilize the handshake secrets 118 to confidentially set up and exchange a shared key. The shared key can be considered a connection secret 128 used during a TLS session.

As part of the TLS handshake, a cipher suite is negotiated between the server and the new client 140. A cipher suite is a set of algorithms used to secure the connection between the new client 140 and a server. Different cipher suites can be used to create the secure connection depending on the configuration of either the server or the new client 140. The cipher suite algorithms can be divided by their functionality. These functionality divisions include, but are not limited to, key exchange/agreement, authentication, block/stream ciphers, and message authentication. The cipher algorithms used by the functionality divisions include, but are not limited to, Rivest-Shamir-Adleman (RSA), Diffie-Hellman, Elliptic-curve Diffie-Hellman (ECDH), Secure Remote Password Protocol (SRP), pre-shared key (PSK), Digital Signature Algorithm (DSA), Elliptic Curve DSA (ECDSA), RC4, Triple data encryption algorithm (Triple DES), Advanced Encryption Standard (AES), International Data Encryption Algorithm (IDEA), Data Encryption Standard (DES), Camellia, Hash-based MD5, and Secure Hash Algorithms (SHA) hash function.

Additionally, if TLS 1.3 protocol is implemented, all encryption and authentication algorithms are combined in the authenticated encryption with associated data (AEAD) encryption algorithm. Hash algorithms implement Hash-based Message Authentication Code (HMAC) and key derivation function (KDF) known as HKDF.

The handshake processor instance 110 is further configured to authenticate the server and the new client 140. A negotiation between the new client 140 and the server can occur to determine which cipher suite is to be used to and public key infrastructure (PKI) can be used to authenticate either the server or the new client 140. PKI is a set of roles, policies, hardware, software, and procedures needed to create, manage, distribute, use, store and revoke digital certificates and manage public-key encryption. A digital certificate, or identity certificate, is an electronic document used to prove the ownership of a public key. The digital certificate can be used to provide information about the identity of its owner and the digital signature of an entity that has verified the certificate's contents. If the signature is valid, and the software (e.g., the new client 140, the server) examining the certificate trusts the issuer, then it can use the public key to communicate securely with the owner of the certificate.

The handshake processor instance 110 is further configured to transmit connection secrets 128, such as a master secret key, to the connection processor instance 120. A client key exchange message can be sent to the new client 140 to allow for the generation of a pre-master key. A pre-master secret can be created by the new client 140 and then shared with the handshake processor instance 110. The handshake processor instance 110 can decrypt the pre-master secret and use that secret to compute a master secret key. The master secret key can be up to 48 bytes in length and is used by both a client and a server to symmetrically encrypt data during a TLS session.

The handshake processor is further configured to delete the connection secrets 128 once they are transmitted to the connection processor instance 120. Deletion can occur using data erasure techniques. Data erasure, also known as data clearing, data deletion, data wiping, or data destruction, refers to methods of overwriting the data to completely destroy all electronic data residing in memory or storage by using zeros and ones to overwrite data onto all sectors of the device. By overwriting the data, the data (e.g., the connection secrets 128) is rendered unrecoverable and achieves data sanitization. In some embodiments, crypto-shredding is used to delete the connection secrets 128. Crypto-shredding refers to the practice of deleting or overwriting encryption keys (e.g., the connection secrets 128).

In some embodiments, the handshake processor instance 110 operates as an isolated instance within the computing environment 100. Process isolation can be implemented onto the handshake processor instance 110. Process isolation is designed to protect each process from other processes on an operating system by preventing processes from accessing the memory of other processes in the same system. This can be accomplished by implementing the handshake processor instance 110 within a virtual address space, where its address space is separated from other processes.

In some embodiments, the handshake processor instance 110 operates as a container within the computing environment 100. Operating system level virtualization refers to a kernel that allows for the existence of multiple isolated user space instances. These user space instances are referred to as containers. Programs running inside of a container, such as the handshake processor instance 110, can only see the container's contents and devices assigned to the container. In addition to embedded isolation mechanisms, the kernel can provide resource-management features to limit the impact of one container's activities on other containers.

In some embodiments, the handshake processor instance 110 operates as a virtual machine within the computing environment 100. The virtual machine may be a system virtual machine or a process virtual machine. System virtual machines provide a substitute for a physical machine. System virtual machines provide the functionality needed to execute an entire operating system. A hypervisor can be used to share and manage hardware, allowing for multiple environments which are isolated from each other. A process virtual machine executes programs in a platform-independent environment.

In some embodiments, physical security controls provide additional security to the handshake processor instance 110. Physical security controls protect against unauthorized physical access to information assets. Typically, physical security controls come in the form of networked devices that are Internet Protocol (IP) enabled. These networked devices can provide an additional layer of defense to safeguard the information stored on the handshake processor instance. For example, a hardware security module (HSM) can be implemented within the computing environment 100 to safeguard the handshake processor instance 110. These safeguards include, but are not limited to, managing digital keys and providing encryption processing. In some embodiments, a hardware security module is used to securely transmit connection secrets from the handshake processor instance 110 to the connection processor instance 120. For example, encryption processing can be implemented on the connection secrets to encrypt the transmission from one instance to another.

The connection processor instance 120 is a component of the TLS separation system 105 configured to process communication between a current client 150 and a server by applying the TLS record protocol during a TLS session, in accordance with embodiments of the present disclosure. The TLS record protocol layers on top of a reliable connection-oriented transport, such as TCP. The Record Protocol also provides data confidentiality using symmetric key cryptography and data integrity using a keyed MAC. These keys are uniquely generated for each session between the current client 150 and the server. The keys are also based on the security parameters agreed upon during the TLS handshake processed by the handshake processor instance 110.

To process communication, the connection processor instance 120 implements TLS Record Protocol functions 124. The TLS Record Protocol functions 124 are a component of the connection processor instance 120 that is responsible for securing application and verifying its integrity and origin. The TLS Record Protocol functions 124 include, but are not limited to, dividing outgoing messages, reassembling incoming messages, compressing outgoing blocks, decompressing incoming blocks, applying a MAC to outgoing messaging, verifying incoming messages using the MAC, encrypting outgoing messages, and decrypting incoming messages. Outgoing messages sent by the connection processor instance 120 are encrypted and transported by the TCP layer to the current client 150.

The connection processor instance 120 utilizes the connection secrets 128 provided by the handshake processor instance 110 to allow for symmetric encryption during the TLS session. Symmetric encryption allows for the same key, such as the master key, to be used for encryption and decryption.

In some embodiments, the connection processor instance 120 operates as an isolated instance within the computing environment 100. Process isolation can be implemented onto the connection processor instance 120. Process isolation is designed to protect each process from other processes on an operating system by preventing processes from accessing the memory of other processes in the same system. This can be accomplished by implementing the connection processor instance 120 within a virtual address space, where its address space is separated from other processes.

In some embodiments, the connection processor instance 120 operates as a container within the computing environment 100. Operating system level virtualization refers to a kernel that allows for the existence of multiple isolated user space instances. These user space instances are referred to as containers. Programs running inside of a container, such as the connection processor instance 120, can only see the container's contents and devices assigned to the container. In addition to embedded isolation mechanisms, the kernel can provide resource-management features to limit the impact of one container's activities on other containers.

In some embodiments, the connection processor instance 120 operates as a virtual machine within the computing environment 100. The virtual machine may be a system virtual machine or a process virtual machine. System virtual machines provide a substitute for a physical machine. System virtual machines provide the functionality needed to execute an entire operating system. A hypervisor can be used to share and manage hardware, allowing for multiple environments which are isolated from each other. A process virtual machine executes programs in a platform-independent environment.

In some embodiments, physical security controls provide additional security to the connection processor instance 120. Physical security controls protect against unauthorized physical access to information assets. Typically, physical security controls come in the form of networked devices that are Internet Protocol (IP) enabled. These networked devices can provide an additional layer of defense to safeguard the information stored on the handshake processor instance. For example, a hardware security module (HSM) can be implemented within the computing environment 100 to safeguard the connection processor instance 120. These safeguards include, but are not limited to, managing digital keys and providing crypto processing.

The proxy server 130 is a component of the computing environment 100 configured to act as an intermediary for requests from the new client 140 or current client 150 seeking communication and resources from the server. The proxy server 130 may be implemented in a variety of ways. The ways include, but are not limited to, tunneling proxy, open proxy, and reverse proxy.

An open proxy refers to a proxy that is a forwarding proxy server that is accessible by any internet user. An open proxy can be configured as an anonymous proxy that reveals its identity as a proxy server but does not disclose the originating IP address of the client. An open proxy can also be a transparent proxy that only identifies itself as a proxy server that also allows for the retrieval of an originating IP address. For example, the proxy server 130 would not reveal the identity of the new client 140 during the TLS handshake process or the current client 150 during the TLS session.

A reverse proxy is a proxy server that appears to clients to be an ordinary server. A reverse proxy forward requests to one or more servers which handle the requests. A response from the proxy server is returned as if it came directly from the original server, leaving the client with no knowledge of the original server. In some embodiments, the TLS separation system 105 operates within the proxy server 130 operating as a reverse proxy. When providing encryption, the proxy server 130 may include TLS acceleration hardware to improve the speed of communication.

The new client 140 is a component of the computing environment 100 configured to connect to a server using the TLS protocol, in accordance with embodiments of the present disclosure. The new client 140 can be a web client requesting authorization to securely connect to a server. In some embodiments, the new client 140 is a web browser configured to receive user input. The web browser may contain dynamic Web pages operating in a Web tier. In some embodiments, the new client 140 is a server (e.g., WINDOWS, Power Systems, IBM I, UNIX, System Z), a personal computer (e.g., desktop, laptop, tablet), or any device capable of communicating over a network and securely connecting to a server using the TLS protocol.

The current client 150 is a component of the computing environment 100 configured to communicate to a server using the TLS protocol, in accordance with embodiments of the present disclosure. The current client 150 can be a web client communicating securely with a server during a TLS session. In some embodiments, the current client 150 is a web browser configured to receive user input. The web browser may contain dynamic Web pages operating in a Web tier. In some embodiments, the current client 150 is a server (e.g., WINDOWS, Power Systems, IBM I, UNIX, System Z), a personal computer (e.g., desktop, laptop, tablet), or any device capable of communicating over a network and securely connecting to a server using the TLS protocol.

It is noted that FIG. 1 is intended to depict the representative major components of an exemplary TLS separation system 105. In some embodiments, however, individual components may have greater or lesser complexity than as represented in FIG. 1, components other than or in addition to those shown in FIG. 1 may be present, and the number, type, and configuration of such components may vary.

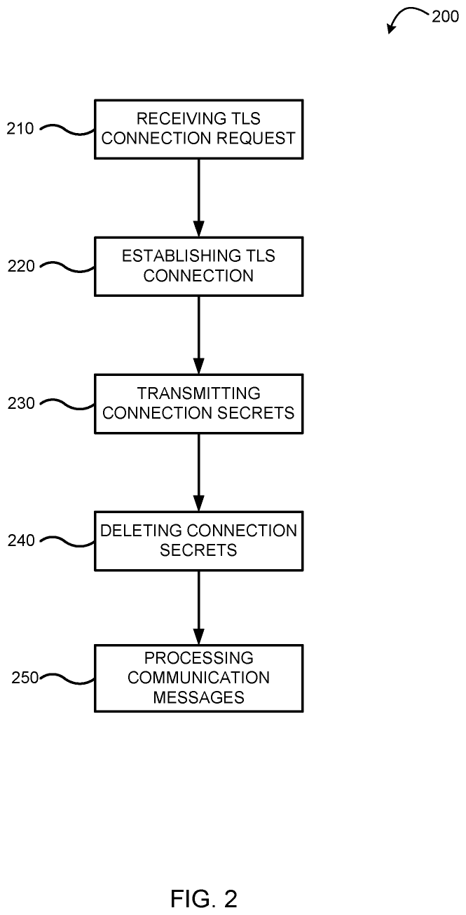

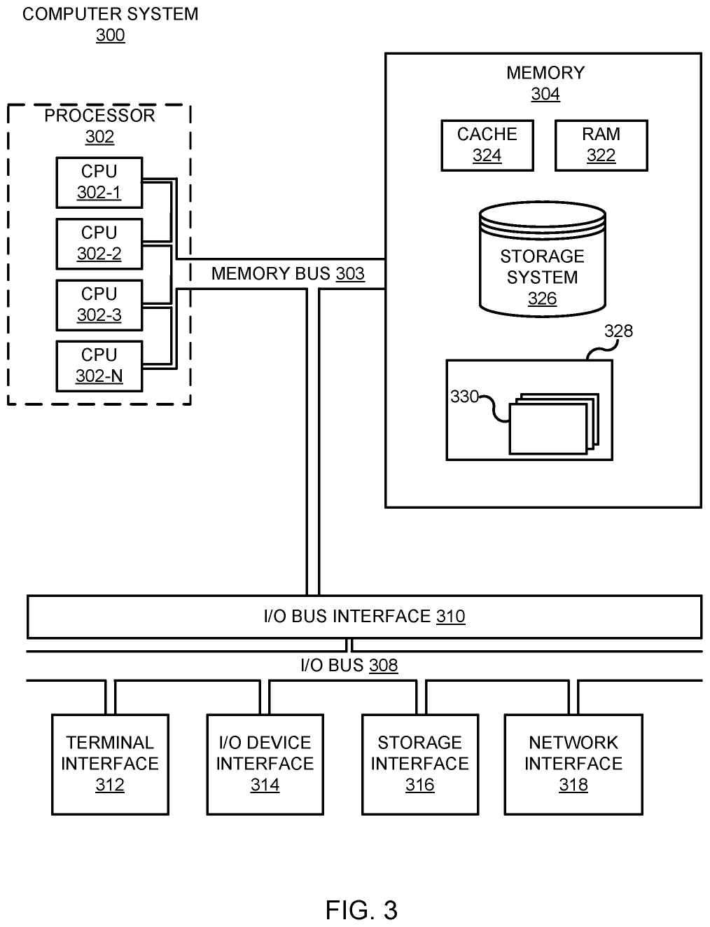

FIG. 2 is a flow diagram illustrating a process 200 for establishing a TLS connection between a client and a server using isolated instances, in accordance with embodiments of the present disclosure. The process 200 may be performed by hardware, firmware, software executing on at least one processor, or any combination thereof. For example, any or all of the steps of the process 200 may be performed by one or more computing devices (e.g., computer system 300 of FIG. 3). To illustrate process 200, but not to limit embodiments, FIG. 2 is described within the context of computing environment 100 of FIG. 1. Where elements described with respect to FIG. 2 are identical to elements shown in FIG. 1, the same reference numbers are used in both Figures.

The process 200 begins by the handshake processor instance 110 receiving a TLS connection request from a new client 140. This is illustrated at step 210. A new client 140 can query a server to request the establishment of a secure connection. This can also occur whenever any other communications use HTTPS, including API calls and DNS over HTTPS queries.

The TLS connection request includes, but is not limited to, a client version, a client random, a session ID, compression methods, cipher suites, and extensions. The new client 140 includes in the client version a list of all the TLS protocol versions that it supports as well as a preferred protocol version. For example, the new client 140 can include each TLS version it supports (e.g., TLS 1.0, 1.1, 1.2, 1.3, etc.). The client random is a 32-byte random number. The client random and a server random are later used to generate the key for encryption. The session ID is used once a TLS session has been configured. The server can search previously cached sessions and resume that session if a match is found. Compression methods are the compression techniques the new client 140 is capable of for compressing TLS packets. By using compression, lower bandwidth usage can be achieved. Similar to the compression methods, the cipher suite is a list of cryptographic algorithms the new client 140 is capable of. The cryptographic algorithms can be used to encrypt key exchanges, authentication, data encryption, and message authentication.

The handshake processor instance 110 establishes a TLS connection between the server and the new client 140. This is illustrated at step 220. To establish a TLS connection, the handshake processor instance 110 replies to the request sent from the new client 140 with a message providing the server's information. This information includes, but is not limited to, the server version, the server random, the session ID if located, cipher suites, and compression methods. The server version informs the new client 140 as to which protocol version it will use from the list provided. The server random is a 32-byte random number used to generate the encryption key. The cipher suites are a selection from the cipher suites offered by the new client 140, and the compression method is a selection of compression method offered by the new client. 160.

The handshake processor instance 110 transmits the server certificate proving the identity of the server to the client. Also contained within the message is the public key of the server. Once the server certificate is sent, a server hello done message is sent followed by receiving a client key exchange message. The handshake processor instance 110 can then receive a pre-master secret from the new client 140. Prior to sending the pre-master secret, the new client 140 encrypts it using the server public key provided from the server certificate.

The handshake processor instance 110 can proceed by computing connection secrets 128, or master key, based on the client random and the server random value exchanged earlier. Typically, a master key is 48 bytes in length and used by the server and client to symmetrically encrypt the data for the rest of the communication. Once the connection secrets 128 have been computed, the TLS connection is established and the new client 140 can be considered a current client 150 with an established TLS session.

The handshake processor instance 110 transmits the connection secrets 128 to the connection processor instance 120. The connection secrets 128 allow the connection processor instance 120 to process the encrypted communication between the server and the current client 150. Once transmitted, the handshake processor instance 110 deletes the connection secrets 128 from its memory. This is illustrated at step 240. The handshake processor instance 110 can perform the deletion in several ways depending on how secure the TLS separation system 105 is configured to be. For example, the handshake processor instance 110 can overwrite data with a random, instead of static, pattern of bits. Each sector of storage where the connection secrets 128 were stored will contain different data. Other deletion techniques include multiple overwrites of the data, firmware level deletion, overwrites using 1s, 0s, and random characters. In some embodiments, the handshake processor instance 110 deletes the connection secrets 128 based on a data wiping standard. For example, the wiping standard can be DoD 5220.22-M ECE, CESG CPA, BSI-GSE, NCSC-TG-025, and any other known data wiping standard.

The connection processor instance 120 processes communication messages between the server and the current client 150. This is illustrated at step 250. Processing communication messages involves reading messages generated by the server and fragmenting the messages into manageable chunks of data. If necessary, the connection processor instance 120 can compress the chunks of data using the agreed upon compression method during the TLS handshake. Also, a MAC can be calculated and the data encrypted using the agreed upon encryption algorithm and connection secrets 128. Once encrypted, the connection processor instance 120 can transmit the encrypted data to the current client 150.

For messages being received from the current client 150, the connection processor instance 120 can receive and decrypt the data received from the current client 150 using the connection secrets 128. Also, the transmitted MAC can be verified and the data decompressed. If the communication message is divided, it can be reassembled and then delivered to the server.

Referring now to FIG. 3, shown is a high-level block diagram of an example computer system 300 (e.g., TLS separation system 105) that may be used in implementing one or more of the methods, tools, and modules, and any related functions, described herein (e.g., using one or more processor circuits or computer processors of the computer), in accordance with embodiments of the present disclosure. In some embodiments, the major components of the computer system 300 may comprise one or more processors 302, a memory 304, a terminal interface 312, a I/O (Input/Output) device interface 314, a storage interface 316, and a network interface 318, all of which may be communicatively coupled, directly or indirectly, for inter-component communication via a memory bus 303, a I/O bus 308, and an I/O bus interface 310.

The computer system 300 may contain one or more general-purpose programmable central processing units (CPUs) 302-1, 302-2, 302-3, and 302-N, herein generically referred to as the processor 302. In some embodiments, the computer system 300 may contain multiple processors typical of a relatively large system; however, in other embodiments the computer system 300 may alternatively be a single CPU system. Each processor 301 may execute instructions stored in the memory 304 and may include one or more levels of on-board cache.

The memory 304 may include computer system readable media in the form of volatile memory, such as random-access memory (RAM) 322 or cache memory 324. Computer system 300 may further include other removable/non-removable, volatile/non-volatile computer system storage media. By way of example only, storage system 326 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, the memory 304 can include flash memory, e.g., a flash memory stick drive or a flash drive. Memory devices can be connected to memory bus 303 by one or more data media interfaces. The memory 304 may include at least one program product having a set (e.g., at least one) of program modules that are configured to carry out the functions of various embodiments.

Although the memory bus 303 is shown in FIG. 3 as a single bus structure providing a direct communication path among the processors 302, the memory 304, and the I/O bus interface 310, the memory bus 303 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 310 and the I/O bus 308 are shown as single respective units, the computer system 300 may, in some embodiments, contain multiple I/O bus interface units, multiple I/O buses, or both. Further, while multiple I/O interface units are shown, which separate the I/O bus 308 from various communications paths running to the various I/O devices, in other embodiments some or all of the I/O devices may be connected directly to one or more system I/O buses.

In some embodiments, the computer system 300 may be a multi-user mainframe computer system, a single-user system, or a server computer or similar device that has little or no direct user interface but receives requests from other computer systems (clients). Further, in some embodiments, the computer system 300 may be implemented as a desktop computer, portable computer, laptop or notebook computer, tablet computer, pocket computer, telephone, smart phone, network switches or routers, or any other appropriate type of electronic device.

It is noted that FIG. 3 is intended to depict the representative major components of an exemplary computer system 300. In some embodiments, however, individual components may have greater or lesser complexity than as represented in FIG. 3, components other than or in addition to those shown in FIG. 3 may be present, and the number, type, and configuration of such components may vary.

One or more programs/utilities 328, each having at least one set of program modules 330 may be stored in memory 304. The programs/utilities 328 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 328 and/or program modules 330 generally perform the functions or methodologies of various embodiments.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

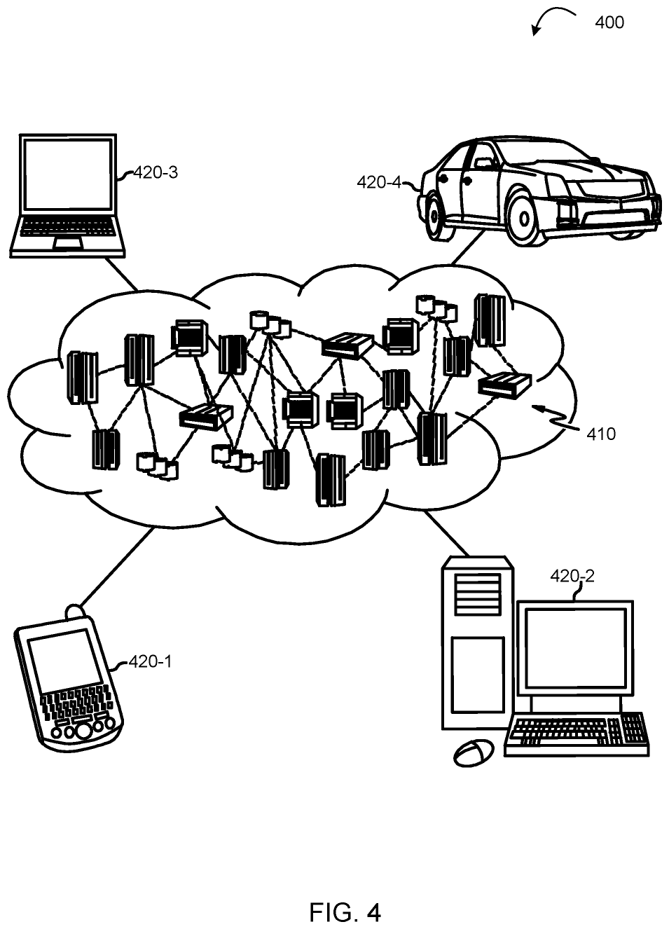

Referring now to FIG. 4, illustrative cloud computing environment 400 is depicted. As shown, cloud computing environment 400 includes one or more cloud computing nodes 410 with which local computing devices used by cloud consumers, such as, for example, personal digital assistant (PDA) or cellular telephone 420-1, desktop computer 420-2, laptop computer 420-3, and/or automobile computer system 420-4 may communicate. Nodes 410 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 420-1 to 420-4 shown in FIG. 4 are intended to be illustrative only and that computing nodes 410 and cloud computing environment 400 can communicate with any type of computerized device over any type of network and/or network addressable connection (e.g., using a web browser).

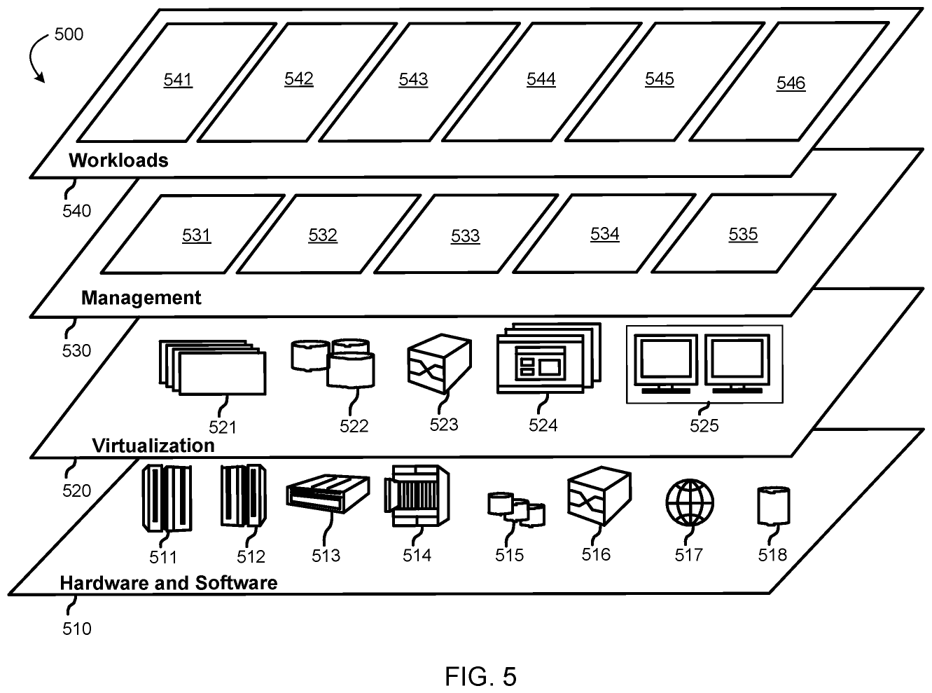

Referring now to FIG. 5, a set of functional abstraction layers 500 provided by cloud computing environment 400 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 510 include hardware and software components. Examples of hardware components include: mainframes 511; RISC (Reduced Instruction Set Computer) architecture-based servers 512; servers 513; blade servers 514; storage devices 515; and networks and networking components 516. In some embodiments, software components include network application server software 517 and database software 518.

Virtualization layer 520 provides an abstraction layer from which the following examples of virtual entities may be provided: virtual servers 521; virtual storage 522; virtual networks 523, including virtual private networks; virtual applications and operating systems 524; and virtual clients 525.

In one example, management layer 530 may provide the functions described below. Resource provisioning 531 provides dynamic procurement of computing resources and other resources that are utilized to perform tasks within the cloud computing environment. Metering and Pricing 532 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 533 provides access to the cloud computing environment for consumers and system administrators. Service level management 534 provides cloud computing resource allocation and management such that required service levels are met. Service Level Agreement (SLA) planning and fulfillment 535 provide pre-arrangement for, and procurement of, cloud computing resources for which a future requirement is anticipated in accordance with an SLA.

Workloads layer 540 provides examples of functionality for which the cloud computing environment may be utilized. Examples of workloads and functions which may be provided from this layer include: mapping and navigation 541; software development and lifecycle management 542; virtual classroom education delivery 543; data analytics processing 544; transaction processing 545; and precision cohort analytics 546 (e.g., the TLS separation system 105).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for performing transport layer security (TLS) protocol functions in separate processing instances, the computer-implemented method comprising:
receiving, by a handshake processor instance, a TLS connection request from a client to a server, the handshake processor instance configured to perform TLS handshake protocol functions;
establishing, by the handshake processor instance, a TLS connection including connection secrets;
transmitting, by the handshake processor instance, the connection secrets to a connection processor instance, the connection processor configured to perform TLS record protocol functions;
deleting the connection secrets stored on the handshake processor instance; and
processing, by the connection processor instance, application data used during communication with the client.

2. The computer-implemented method of claim 1, wherein establishing the TLS connection comprises:
transmitting server information to the client;
transmitting a server certificate to the client, wherein the server certificate includes a server identification and a public key to the client;
transmitting a server hello done message to the client;
receiving a client certificate and a client key exchange from the client;
receiving a pre-master secret from the client, wherein the pre-master secret is encrypted using the public key;
decrypting the pre-master secret using a private key;
computing the connection secrets; and
receiving a first encrypted message from the client using the connection secrets.

3. The computer-implemented method of claim 1, wherein processing the application data comprises:
accessing the connection secrets received from the handshake processor instance;
receiving encrypted client data from the client;
decrypting the encrypted client data into client data using the connection secrets;
encrypting the application data generated in response to the client; and
transmitting the encrypted application data to the client.

4. The computer-implemented method of claim 1, wherein deleting the connection secrets includes performing a deletion technique to a memory location where the connection secrets were stored on the handshake processor instance.

5. The computer-implemented method of claim 1, further comprising:
severing a communication connection between the handshake processor instance and the connection processor instance upon transmitting the connection secrets.

6. The computer-implemented method of claim 1, wherein the handshake processor instance and the connection processor instance operate on separate containers within a distributed system.

7. The computer-implemented method of claim 1, wherein the handshake processor instance and the connection processor instance operate on separate virtual machines within a computing environment.

8. The computer-implemented method of claim 1, wherein transmitting comprises:
establishing a secure connection between the handshake processor instance and the connection processor instance;
encrypting the connection secrets using physical security controls; and
transmitting the encrypted connection secrets to the connection processor instance.

9. A computer program product comprising a computer readable medium having program instructions embodied therewith, the program instructions being executable by a processor to cause the processor to perform a method for performing TLS protocol functions in separate processing instances, the method comprising:
receiving, by a handshake processor instance, a TLS connection request from a client to a server;
establishing, by the handshake processor instance, a TLS connection including connection secrets;
transmitting, by the handshake processor instance, the connection secrets to a connection processor instance;
deleting the connection secrets stored on the handshake processor instance; and
processing, by the connection processor instance, application data.

10. The computer program product of claim 9, wherein establishing the TLS connection comprises:
transmitting server information to the client;
transmitting a server certificate to the client, wherein the server certificate includes a server identification and a public key to the client;
transmitting a server hello done message to the client;
receiving a client certificate from the client;
receiving a client key exchange from the client;
receiving a pre-master secret from the client, wherein the pre-master secret is encrypted using the public key;
decrypting the pre-master secret using a private key;
computing the connection secrets; and
receiving a first encrypted message from the client using the connection secrets.

11. The computer program product of claim 9, wherein deleting the connection secrets includes performing a deletion technique to a memory location where the connection secrets were stored on the handshake processor instance.

12. The computer program product of claim 9, further comprising:
severing communication connection between the handshake processor instance and the connection processor instance upon transmitting the connection secrets.

13. The computer program product of claim 9, wherein the handshake processor instance and the connection processor instance operate on separate containers within a distributed system.

14. The computer program product of claim 9, wherein the handshake processor instance and the connection processor instance operate on separate virtual machines within a computing environment.

15. The computer program product of claim 9, wherein transmitting comprises:
establishing a secure connection between the handshake processor instance and the connection processor instance;
encrypting the connection secrets by implementing physical security controls; and
transmitting the encrypted connection secrets to the connection processor instance.

16. A Transport Layer Security (TLS) separation system comprising:
at least one processor;
at least one memory component;
a handshake processor instance configured to perform a TLS handshake between a server and a client; and
a connection processor instance configured to process communication between the server and the client during a TLS session, wherein the connection processor instance is isolated from the handshake processor instance.

17. The TLS separation system of claim 16, wherein the handshake processor instance is further configured to transmit connection secrets generated during the TLS handshake between the server and the client.

18. The TLS separation system of claim 17, wherein the handshake processor instance is further configured to delete the connection secrets upon transmitting the connection secrets to the connection processor instance.

19. The TLS separation system of claim 16, wherein the handshake processor instance and the connection processor instance operate within separate containers.

20. The TLS separation system of claim 16 further comprising:
a physical security control configured to manage digital keys and provide encryption processing between the handshake processor instance and the connection processor instance.
